(19) United States
(12) Patent Application Publication
(10) Pub. No.: US 2016/0315804 A1
(43) Pub. Date: Oct. 27, 2016

(54) METHOD AND SYSTEM FOR UNIQUE ENDURING IDENTIFICATION OF A HARDWARE OR SOFTWARE ENTITY WITHIN AN IT LANDSCAPE

(71) Applicant: iQuate Inc., San Francisco, CA (US)

(72) Inventors: Brian P. O'Byrne, Broadford (IE); Jason J. Keogh, Dublin (IE); Patrick J. Moloney, Sydney (AU); Jonathan G.B. Schnittger, Dublin (IE); Rafe G. Slattery, Dublin (IE); James Wilson, Dublin (IE)

(21) Appl. No.: 14/696,753

(22) Filed: Apr. 27, 2015

(51) Int. Cl. H04L 12/24; H04L 29/12

(52) U.S. Cl. CPC H04L 41/0803; H04L 41/085; H04L 41/0866; H04L 61/2007

(57) ABSTRACT

Methods, computer-readable storage media, and systems that uniquely identify hardware entities and applications within a computing environment. This is done by (1) using retrieved data set that describe the attributes of the computing environment hardware entities; (2) applying strategies that combine attributes of real and virtual hardware entities to identify each hardware entity within the retrieved data set; (3) using retrieved data set that describe the attributes of the computing environment software entities; (4) applying strategies that identify combine attributes of software entities installed on a hardware entity; (5) providing merge strategies that allow values of the attributes of hardware entities to be modified but retain an existing hardware entity identifier; (6) providing merge strategies that allow values of the attributes of applications to be modified but retain an existing application identifier.

### BACKGROUND

1. Field

Disclosed embodiments generally relate to identification of entities in a computing environment, and, in particular, to uniquely identifying entities when the computing environment is composed of heterogeneous, virtualized, and clustered computing environments.

2. Description of Related Art

Information Technology Asset Management (ITAM) and Software Asset Management (SAM) systems identify and track hardware and software entities within a computing environment over time and across configuration changes. A hardware entity is a set of hardware components, including a central processor, data storage hardware components, such as hard-drives, network communication cards, and external interfaces that may or may not be graphically based. A hardware entity may be either a physical hardware entity or virtual hardware entity. A software entity is a set of machine code that is executed on a physical or virtual hardware entity. Within a given computing environment, hardware and software entities are subject to configuration change. These configuration changes present a challenge when identifying and tracking the entities over time.

Specifically, identification of a hardware entity in a computing environment is typically based on attributes of the entity such as: a hostname, a globally unique identifier called a Media Access Control (MAC) address retrieved from the installed Network Interface Card (NIC), an Internet Protocol (IP) address or a number of other possible attributes. All the values of these attributes may be modified via simple configuration change as part of the day-to-day operation of the hardware entity. For the purposes of example, consider that identification of the hardware entities within a computing environment uniquely identifies all hardware entities using a single attribute of the entity: the MAC address.

Hardware Entity ID=MAC Address₁

The replacement of a NIC due to hardware failure is a simple configuration change. As a result, the hardware entity now has a different MAC address derived from the new NIC.

Hardware Entity ID=MAC Address₂

This configuration change modifies the value used to generate the hardware entity identifier, thus creating a new identifier for the same hardware entity and losing the association between the old identifier and the hardware entity. In an asset management system, such as an ITAM system, this loss of association between the old identifier and the hardware entity results in the system not being able to accurately identify the entity as being the same entity prior to the configuration change.

This problem of identification also applies to the identification of software entities within a computing environment. Identification of a software entity included in a computing environment is typically based on an attribute (or attributes) of the entity. For the purposes of example, consider that an identification of the software entities within a computing environment uniquely identifies all software entities using multiple attributes of the entity—the application Product name and application install location.

ApplicationID=ProductName₁+InstallLoc₁

If a configuration change modifies one of the attributes used as part of the software entity identifier then a new application identifier is created (and the old identifier value is lost). For example, reinstalling the product in a new installation location will create a new Application Identifier.

ApplicationID=ProductName₁+InstallLoc₂

Identification of entities is made more complex with the introduction of High-Availability (HA) technologies, such as clustering. Management of all hardware and software entities within a heterogeneous system (real or virtualized) typically includes clustered environments that perform load-sharing and fail-over operations. A clustered environment typically duplicates attributes of the shared hardware entities or software entities, in order to provide a consistent access method during cluster member failure. Consider, as an example, the scenario where two hardware entities within a cluster, providing high-availability, share an IP address so that in the event of failure, the backup hardware entity will be accessible to the client without resorting to reconfiguration of IP addresses.

Hardware entityID1_{cluster1}=HOSTNAME₁+MAC Address₁+IP Address₁

Hardware entityID2_{cluster1}=HOSTNAME₂+MAC Address₂+IP Address₂

Tracking of clustered hardware entities is an essential part of the inventory process.

### BRIEF DESCRIPTION OF DRAWINGS

FIG. 1 is a high-level block diagram of an example computing environment and an analysis system.

FIG. 2 is a block diagram of the analysis system of FIG. 1.

FIG. 3 illustrates the example stages implemented by the analysis system when identifying a hardware entity.

FIG. 4 illustrates the example stages implemented by the analysis system when identifying a software entity.

FIG. 5 illustrates an embodiment of a process for identifying an entity within a computing environment.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

### Overview

A computing environment typically includes hardware and software entities (collectively, “entities”). An important aspect of managing the computing environment is identifying and keeping track of the different entities over time such that those assets can be properly maintained and accounted for. According to disclosed embodiments, an analysis system identifies an entity by (i) determining attributes associated with the entity and (ii) combining one or more of those attributes to determine, with a certain confidence, that the entity is the same as a previously identified entity. The analysis system is configured with a plurality of merge strategies, where each merge strategy generates an entity identifier for an entity by combining one or more of the attributes determined for the entity. Each merge strategy is associated with a quality level dependent on the number and types of attributes that are combined. A match between an identifier generated based on previously collected attributes and an identifier generated based on the currently collected attributes indicates, with a confidence tied to the quality level associated with the merge strategy, that the entity is the same as the entity associated with the previously collected attributes.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### Example Computing System

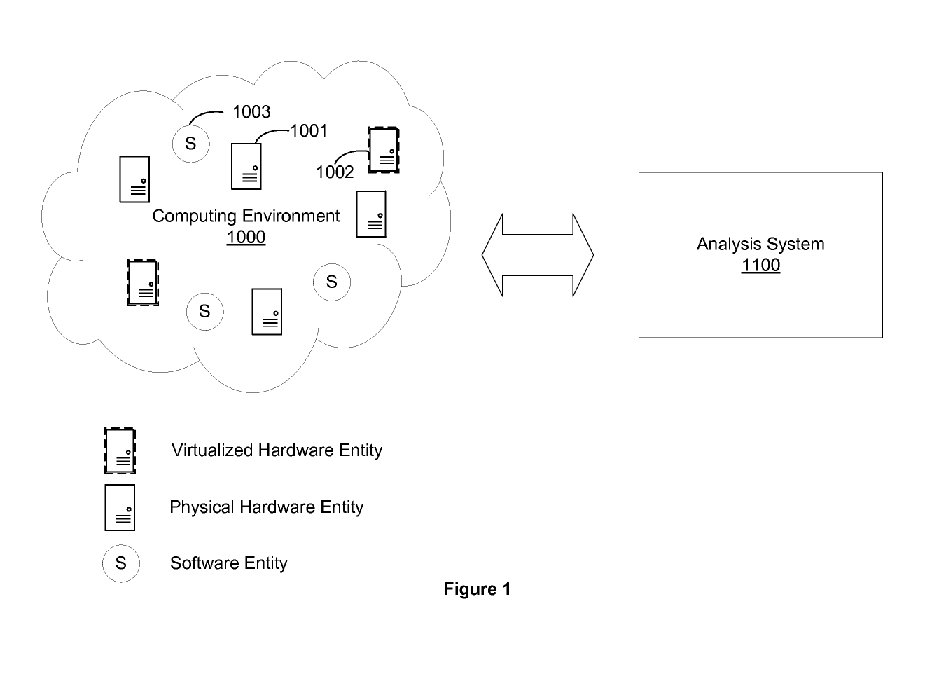

FIG. 1 is a high-level block diagram of an example computing environment 1000 and an analysis system 1100. The computing environment 1000 includes a plurality of hardware entities that collectively store and access data for a business or any other organization or individual. The computing environment 1000 includes a plurality of hardware entities, such as physical hardware entity 1001 and virtual hardware entity 1002. The hardware entities may execute different software entities, such as software entity 1003. The computing environment 1000 may be centralized or geographically dispersed. In one embodiment, the computing environment 1000 is heterogeneous. A heterogeneous computing environment aggregates multiple different technologies including hardware vendors, operating systems, clustering, and virtualization environments.

The analysis system 1100 identifies and tracks the different entities included in the computing environment 1000 over time. Specifically, the analysis system 1100 collects and stores attribute information associated with different entities in the computing environment. Each time the computing environment 1000 is scanned for attribute information, the analysis system processes the newly collected attribute information to determine whether each entity can be matched to a previously identified entity or whether the entity is newly added to the computing environment 1000.

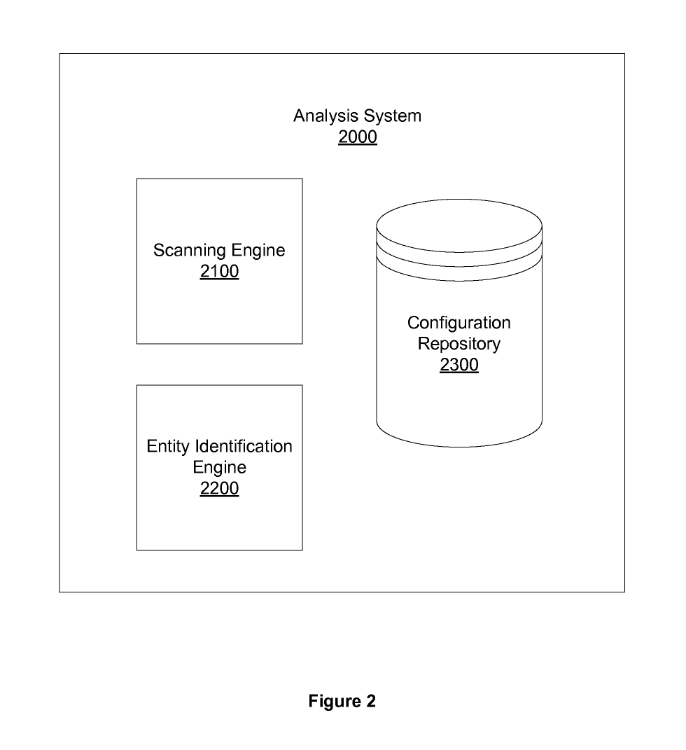

FIG. 2 is a block diagram of the analysis system 1100 of FIG. 1. The analysis system 1100 includes a scanning engine 2100, an entity identification engine 2200, and a configuration repository 2300.

The scanning engine 2100 periodically scans the computing environment 1000 to gather attribute information related to the entities included in the computing environment. In one embodiment, the attribute information gathered by the scanning engine 2100 includes information about the hardware (e.g., central processing unit (CPU) manufacturer, CPU model, CPU clock cycle, number of cores in the CPU, system manufacturer, and number of CPUs persisting in the system), system software (e.g., clustering configuration, virtualization configuration, operating system), and applications (e.g., manufacturer, version, options installed, options in use, users enabled).

In one embodiment, to gather attribute information related to hardware entities, the scanning engine 2100 identifies the existence of real or virtual hardware entities within the computing environment 1000. The scanning engine 2100 retrieves hardware entity facet information related to those hardware entities from the computing environment 1000. A number of methods may be used to retrieve attribute information for hardware entities within the computing environment 1000.

In one embodiment, to gather attribute information related to software entities, the scanning engine 2100 identifies the existence of software entities that execute on the hardware identities within the computing environment 1000. The scanning engine 2100 retrieves software entity attributes related to those software entities from the computing environment 1000. A number of methods may be used to identify software entities within a computing environment.

The scanning engine 2100 stores attribute information gathered by the scanning engine 2100 in the configuration repository 2300. The configuration repository 2300 maintains an attribute profile of different entities in the computing environment 1000. An attribute profile for a given entity stores all the attribute information related to that entity that is gathered over time.

The entity identification engine 2200 processes attribute information collected by the scanning engine 2100 during a scanning operation of the computing environment 1000 to identify the different entities within the computing environment 1000. The entity identification engine 2200 aims to match the attribute information collected for a given entity with attribute information previously collected for that entity so that the configuration repository 2300 stores only one comprehensive profile of that entity. This ensures that the entity identification engine 2200 identifies an entity correctly without duplication of profiles.

The entity identification engine 2200 identifies the entities using a cascading merge strategy approach. In operation, the entity identification engine 2200 is configured with a plurality of merge strategies that each takes as input a different set of attributes of an entity and generates a processed sequence from the attributes. Each merge strategy is associated with sequence strength value based on the number of attributes and/or the type of combination operations used to generate the processed sequence. The strength of an attribute match is not directly correlated to the number of attributes used within a merge strategy.

When determining whether a given entity matches an entity profile in the configuration repository 2300, the entity identification engine 2200 iteratively executes the merge strategies to identify a match between processed sequences generated from a current set of attributes and the previously stored set of attributes of the various entities. If a match is found between processed sequences generated from a merge strategy associated with a high sequence strength value, then the quality of the match is deemed to be high and the identification engine 2200 can determine, with high confidence, that the entities match. If a match is found between processed sequences generated from a merge strategy associated with a low sequence strength value, then the quality of the match is deemed to be low and the identification engine 2200 can determine, with low confidence, that the entities match. If no match is found, then the given entity does not match an entity profile and the entity identification engine 2200 creates a new entity profile for the entity within the configuration repository 2300.

### Example Identification of Hardware Entities

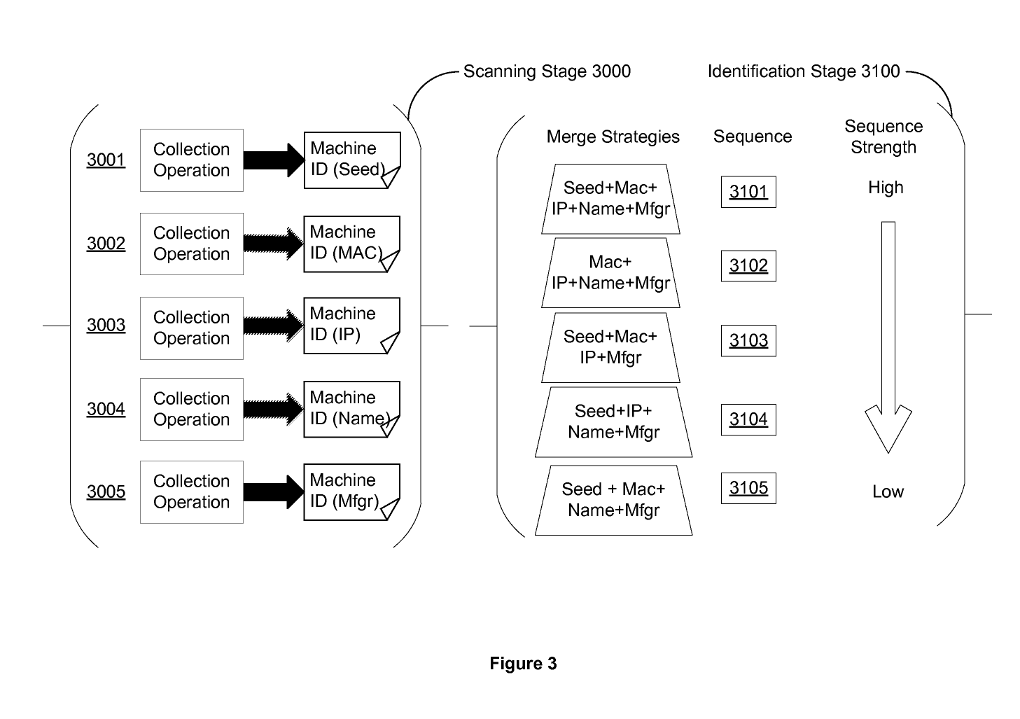

FIG. 3 illustrates the example stages implemented by the analysis system 1100 when identifying a hardware entity. In the scanning stage 3000, the analysis system 1100 collects attribute information related to a hardware entity from the computing environment 1000. In one embodiment, each attribute is retrieved from the hardware entity using one or more operations. These operations may be issued remotely or locally to the hardware entity.

In the illustrated embodiment, the analysis system 1100 collects the following attributes from the hardware entity: (i) a machine seed, i.e., a unique identifier provided by the operating system, via operation 3001, (ii) a MAC address from the network interface card via operation 3002, (iii) the machine internet protocol (IP) address via operation 3003, (iv) the machine name via operation 3004, and (v) the machine manufacturer via operation 3005. Persons skilled in the art would recognize that any other attribute of a hardware entity may be similarly collected by the analysis system 1100 in the scanning stage 3000.

In the identification stage 3100, the analysis system 1100 iteratively executes the available merge strategies until a match is found between an identifier generated based on the attributed collected in the scanning stage 3000 and attributes previously collected and stored in the configuration repository 2300.

In the illustrated embodiment, the marge strategy associated with the highest sequence strength combines all available attributes to generate the sequence 3101. The next merge strategy is associated with a lower sequence strength and combines a fewer number of the available attributes to generate the sequence 3102. Each of the remaining sequences, 3103, 3104, and 3105, is generated by a merge strategy that combine fewer number of the available attributes that the previous merge strategies and has a lower sequence strength than the previous merge strategies. The last merge strategy in the illustrated list combines the least number of attributes identified as acceptable for generating an acceptable quality of match.

Each merge strategy is composed of multiple merge conditions, where each merge condition identifies a condition attribute and a test condition to which the test is applied. One example for a hardware entity merge condition is the hardware entity IP address attribute. In such an example, the merge test may be an ‘exact match’ and the merge value is the IP address of the hardware entity for which the merge strategy is being executed. This merge condition for two hardware entities would be considered TRUE if the two hardware entities have exactly matching IP addresses. Additional merge tests that allow of the comparison of entity attributes are within the scope here.

The different merge strategies may use many merge conditions for identification purposes. The number of merge conditions used in the identification process does not have a direct correlation with the confidence in the hardware entity uniqueness. Specifically, individual entity attributes may have their own implicit value quality values when associated with uniqueness. However, the larger the number of attributes, typically, the greater the quality in identification uniqueness.

The use of multiple strategies is necessary as there are occasions when an absolute match is not possible. The use of a lower quality identification allows for entity matching when (1) a component of the information is missing (i.e. no values has been associated with the entity attribute, (2) a command that retrieves the value for an attribute of the entity fails, or (3) a component has been modified (which changes the attribute value for an entity) e.g. a Network Card (NIC) has been replaced due to failure.

### Example Identification of Software Entities

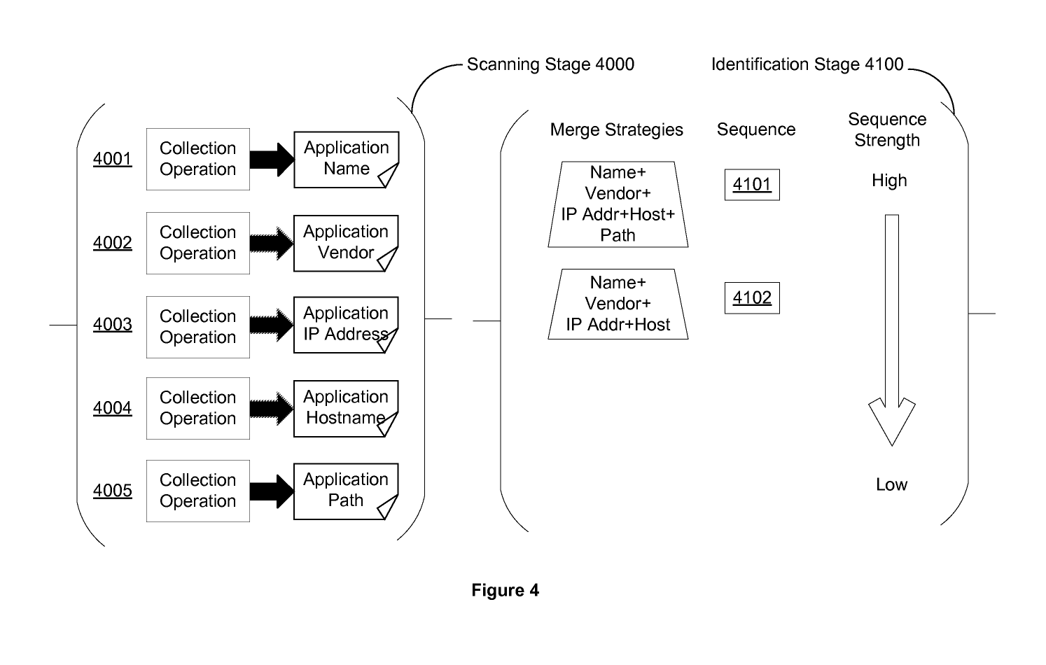

FIG. 4 illustrates the example stages implemented by the analysis system 1100 when identifying a software entity. In the scanning stage 4000, the analysis system 1100 collects attribute information related to a software entity executing on one of the identified hardware entities in the computing environment 1000. In one embodiment, each attribute is retrieved from the hardware entity using one or more operations. These operations may be issued remotely or locally to the software entity.

In the illustrated embodiment, the analysis system 1100 collects the following attributes from the software entity: (i) the application name via collection operation 4001, (ii) application vendor via collection operation 4002, (iii) the application IP address via collection operation 4003, (iv) the application hostname via collection operation 4004, and (v) the application path via collection operation 4005. Persons skilled in the art would recognize that any other attribute of a software entity may be similarly collected by the analysis system 1100 in the scanning stage 4000.

In the identification stage 4100, the analysis system 1100 iteratively executes the available merge strategies until a match is found between an identifier generated based on the attributed collected in the scanning stage 4000 and attributes previously collected and stored in the configuration repository 2300.

In the illustrated embodiment, the marge strategy associated with the highest sequence strength combines all available attributes to generate the sequence 4101. The next merge strategy is associated with a lower sequence strength and combines a fewer number of the available attributes to generate the sequence 4102. This merge strategy in combines the least number of attributes identified as acceptable for generating an acceptable quality of match.

Each merge strategy is composed of multiple merge conditions, where each merge condition identifies a condition attribute and a test condition to which the test is applied. One example for a software entity merge condition is the software entity host path attribute. In such an example, the merge test may be an ‘exact match’ and the merge value is the application path of the software entity for which the merge strategy is being executed. This merge condition for two software entities would be considered TRUE if the two software entities have exactly matching application path. Additional merge conditions that allow for the comparison of entity attributes are within the scope here.

### Example Process

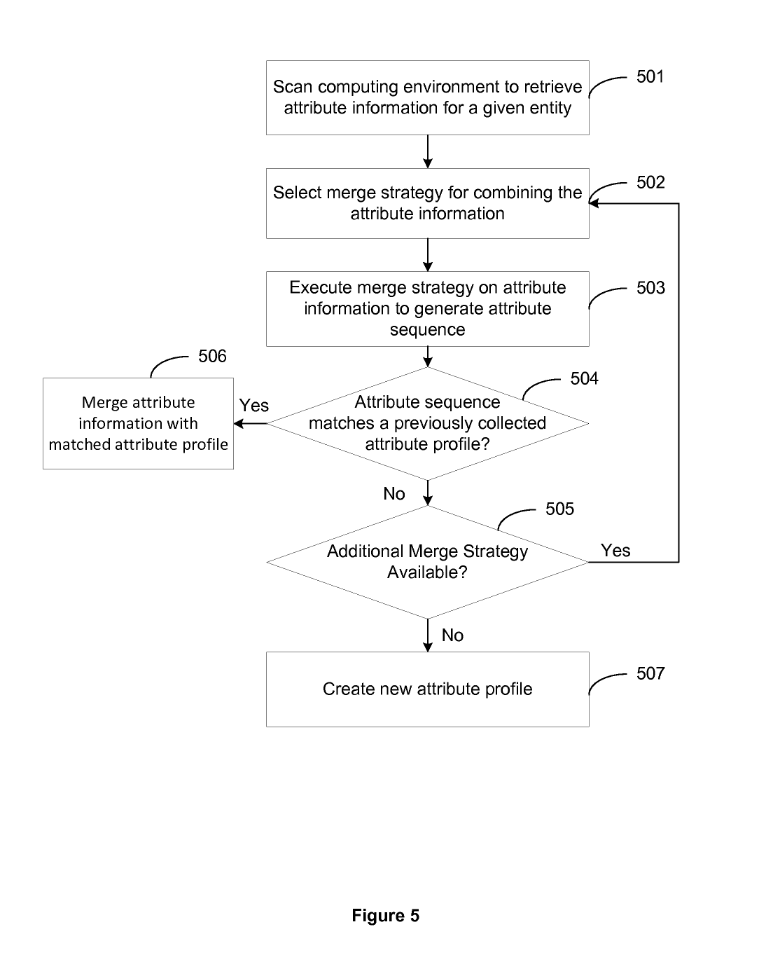

FIG. 5 illustrates an embodiment of a process for identifying an entity within a computing environment. At step 501, the analysis system 1100 scans a computing environment to retrieve attribute information for a given entity. In one embodiment, the analysis system 1100 executes one or more operations to query the entity for different attribute information. At step 502, the analysis system 1100 selects a merge strategy for combining the attribute information. In one embodiment, the analysis system 1100 selects the merge strategy that combines the most number of attributes. At step 503, the analysis system 1100 executes the selected to generate an attribute sequence associated with the entity. At step 504, the analysis system 1100 determines whether the generated attribute sequence matches a previously collected attribute profile stored in the configuration repository 2300.

At step 505, when the generated sequence does not match a previously collected attribute profile, additional merge strategies are sought and the identification sequence returns to step 502. If no additional merge strategies are identified at step 505, then, at step 507, the analysis system 1100 creates a new attribute profile for storage in the configuration repository 2300. Conversely, at step 506, when the generated sequence matches a previously collected attribute profile, the analysis system 1100 merges the attribute information with the matched attribute profile.

The disclosed embodiments allow the analysis system 1100 to track entities over time even when the entities are re-configured such that one or more attributes of the entities change.

### Additional Configuration Considerations

Some portions of the above description describe the embodiments in terms of algorithmic processes or operations. These algorithmic descriptions and representations are commonly used by those skilled in the arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of computer-readable storage medium suitable for storing electronic instructions, and each coupled to a computer system bus. Furthermore, the computers referred to in the specification may include a single processor or may be architectures employing multiple processor designs for increased computing capability.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for performing the methods described herein. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus disclosed herein without departing from the spirit and scope as defined in the appended claims.

What is claimed is:

1. A computer-implemented method comprising:
identifying a set of configuration attributes associated with a first entity included in a computing environment;
generating an attribute sequence from the set of configuration attributes based on at least one merge strategy of a plurality of merge strategies, each of the merge strategies configured to merge at least a subset of the set of configuration attributes to generate a different attribute sequence;
determining whether the attribute sequence matches a previous attribute sequence generated based on the merge strategy; and
when the attribute sequence matches the previous attribute sequence, determining that the first entity is the same entity for which the previous attribute sequence was generated, or
when the attribute sequence does not match the previous attribute sequence, determining that the first entity is not the same entity for which the previous attribute sequence was generated.

2. The method of claim 1, wherein the first entity is a hardware entity, and the set of configuration attributes includes at least one of a MAC address, an internet protocol address, and manufacturer information.

3. The method of claim 1, wherein the first entity is a software entity, and the set of configuration attributes includes at least one of a version number, a vendor, a local host, and a pathname.

4. The method of claim 1, wherein identifying the set of configuration attributes comprises executing one or more operations for querying the first entity to retrieve the set of configuration attributes.

5. The method of claim 1, wherein generating the attribute sequence comprises selecting a first merge strategy from the plurality of merge strategies based on a sequence strength associated with the first merge strategy.

6. The method of claim 5, wherein the sequence strength associated with the first merge strategy is indicative of a number of attributes that the first merge strategy merges to generate a corresponding attribute sequence.

7. The method of claim 5, wherein the sequence strength associated with the first merge strategy is indicative of one or more types of attributes that the first merge strategy merges to generate a corresponding attribute sequence.

8. The method of claim 5, wherein, when the attribute sequence matches the previous attribute sequence, determining a quality of the match based on the sequence strength associated with the first merge strategy.

9. The method of claim 1, wherein generating the attribute sequence comprises determining that a match was not found when a first merge strategy was executed and selecting a second merge strategy from the plurality of merge strategies, a sequence strength associated with the second merge strategy being lower than a sequence strength associated with the first merge strategy.

10. The method of claim 1, wherein, when the attribute sequence does not match the previous attribute sequence, creating a new entity profile in association with the first entity and storing the set of configuration attributes in the new entity profile.

11. A computer readable medium storing instructions that, when executed by a processor, cause the processor to:
identify a set of configuration attributes associated with a first entity included in a computing environment;
generate an attribute sequence from the set of configuration attributes based on at least one merge strategy of a plurality of merge strategies, each of the merge strategies configured to merge at least a subset of the set of configuration attributes to generate a different attribute sequence;
determine whether the attribute sequence matches a previous attribute sequence generated based on the merge strategy; and
when the attribute sequence matches the previous attribute sequence, determine that the first entity is the same entity for which the previous attribute sequence was generated, or
when the attribute sequence does not match the previous attribute sequence, determine that the first entity is not the same entity for which the previous attribute sequences was generated.

12. The computer readable medium of claim 11, wherein the instructions further cause the processor to identify the set of configuration attributes by executing one or more operations for querying the first entity to retrieve the set of configuration attributes.

13. The computer readable medium of claim 11, wherein the instructions further cause the processor to generate the attribute sequence by selecting a first merge strategy from the plurality of merge strategies based on a sequence strength associated with the first merge strategy.

14. The computer readable medium of claim 13, wherein the sequence strength associated with the first merge strategy is indicative of a number of attributes that the first merge strategy merges to generate a corresponding attribute sequence.

15. The computer readable medium of claim 13, wherein the sequence strength associated with the first merge strategy is indicative of one or more types of attributes that the first merge strategy merges to generate a corresponding attribute sequence.

16. The computer readable medium of claim 13, wherein the instructions further cause the processor to, when the attribute sequence matches the previous attribute sequence, determine a quality of the match based on the sequence strength associated with the first merge strategy.

17. The computer readable medium of claim 11, wherein the instructions further cause the processor to generate the attribute sequence by determining that a match was not found when a first merge strategy was executed and selecting a second merge strategy from the plurality of merge strategies, a sequence strength associated with the second merge strategy being lower than a sequence strength associated with the first merge strategy.

18. The computer readable medium of claim 11, wherein the instructions further cause the processor to, when the attribute sequence does not match the previous attribute sequences, create a new entity profile in association with the first entity and storing the set of configuration attributes in the new entity profile.

19. A computer system, comprising:
one or more computer processors; and
an analysis system executing on the one or more computer processors and configured to:
identify a set of configuration attributes associated with a first entity included in a computing environment,
generate an attribute sequence from the set of configuration attributes based on at least one merge strategy of a plurality of merge strategies, each of the merge strategies configured to merge at least a subset of the set of configuration attributes to generate a different attribute sequence,
determine whether the attribute sequence matches a previous attribute sequences generated based on the merge strategy, and
when the attribute sequence matches the previous attribute sequence, determine that the first entity is the same entity for which the first previous attribute sequence was generated, or
when the attribute sequence does not match the previous attribute sequences, determine that the first entity is not the same entity for which the previous attribute sequences was generated.

20. The computer system of claim 19, wherein the analysis system is configured to generate the attribute sequence by selecting a first merge strategy from the plurality of merge strategies based on a sequence strength associated with the first merge strategy.
